(19) United States
(12) Patent Application Publication
(10) Pub. No.: US 2011/0168104 A1
(43) Pub. Date: Jul. 14, 2011

(54) Animal Cage having a Removable Divider with Door

(76) Inventors: Michael L. Matteson, Kansas City, KS (US); Karl J. Donahue, Overland Park, KS (US)

(21) Appl. No.: 12/687,221

(22) Filed: Jan. 14, 2010

(51) Int. Cl. A01K 1/03

(52) U.S. Cl. 119/472; 119/473; 119/481

(57) ABSTRACT

An animal cage including a plurality of joined walls defining an interior and presenting a first opening for accessing the interior. A door that is mounted over the first opening is moveable between closed and open positions alternately limiting and allowing access to the interior. A divider is operable from outside the cage to removably engage at least one of the walls for dividing the interior into first and second chambers. The divider presents an opening for passage between the chambers. A door panel is supported by the divider and is moveable relative to the divider between a closed position blocking the opening in the divider and an open position allowing passage between the first and second chambers. The cage may comprise a cage run consisting of one or more elongated enclosures that can be divided with the removable dividers into a plurality of cage compartments.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to an animal cage, and more particularly, to an animal cage having a removable divider with door.

2. Description of Related Art

A variety of different animal cages are used by veterinarians, pet owners, pet stores, and animal care professionals to safely house and contain an animal or animals. Typical animal cages include a plurality of joined walls that enclose an interior space and a door for accessing the cage's interior. These cages are constructed out of various materials including steel, plastic, fiberglass and wood. Just as animals come in all different shapes and sizes, animal cages are built with various dimensions and sizes.

The quandry for animal care professionals who see a variety of animals for a variety of reasons on any given day is to determine the kind and size of cages needed for their practice. This will be determined by the number, nature and size of the animals for which care is to be provided, and the kind of care to be provided. Cages need to be appropriately sized for the animals to be housed. They need to be big enough, but not too big. Cages also need to be appropriate for their intended use. For example, where cages are to be used for communal housing of animals (such as cats), they may need special design features. Furthermore, when cages are to be used in a post surgical or disease control setting, stainless steel construction may be necessary for infection control. Finally, if the caging is to be used for long term boarding, a more spacious kennel run is preferred. As a result, practitioners need cages having varying sizes, composition and designs and that are adaptable for a variety of different applications.

The challenge presented to practitioners with respect to appropriate cage size and design has a lot to do with traditional cage construction. Cages by their nature are intended to keep animals confined within a defined area. Although this serves a most necessary purpose, it also creates some practical problems. Commercially available cages generally provide for a fixed interior space that is not typically expandable or easily modified. Resulting space constraints can limit the size of an animal that can be housed. In addition, a cage may not be appropriate for a smaller animal where the provided space is too large. The result is that practioners are often forced to buy an array of different sized cages and make them work even where the cage size or design is not optimal for a particular situation.

Traditional cage designs also raise animal handling issues. After an animal is confined in a cage for any length of time, sanitation issues arise. When a cage needs to be cleaned, the animal or animals within the cage must be removed. In addition, when animals are housed in a communal setting, there is often a need to separate the animals for behavioral, sanitary or medical reasons. Both of these scenarios typically require accessing the inside of the cage and physically removing the animal involved. The animal then must be transferred to a separate cage.

A variety of cage design features have been developed in an effort to address some of the limitations associated with traditional cages. For example, with respect to the need for a cage suitable to house both large and small animals, cages have been designed to receive a solid removable divider panel that allows a large cage to be divided into smaller spaces. In addition, in order to facilitate the movement of an animal from one cage into another, “passthrough” features have also been developed which provide an opening between adjacent cages that share a common sidewall or have abutting sidewalls. This opening allows the animal to pass through between the cages.

One of the simpler “passthrough” features developed to date is a sidewall portal where access is controlled by a portal cover that rotates over the outside of the opening. This most common approach is seen in smaller cages especially those used for cats. One of the biggest drawbacks to this feature is that the cover must be operated from inside the cage. Thus, a user is required to deal with animal handling issues while trying to open or close the cover.

Another “passthrough” feature utilized in commercial cages is a guillotine door which does not require access to the inside of the cage in order to open or close the opening. Instead a door is attached to a wire and pulley system operational from outside the cage. The door is housed within the sidewall of a cage and retracts up into the sidewall when it is opened. This is a very effective but also very costly system. In addition, it normally works only in kennels that have dual paneled sidewalls that can house the door. Thus, it is not readily adaptable for use in the most common single wall stainless steel small animal cage.

Other limitations of the guillotine door are apparent when it is deployed in a bank of larger cages or runs. A bank of larger cages often includes a bottom row of cages and a top row of cages vertically aligned with the bottom row. Each of the adjacent cages on the bottom row share a common sidewall that has a passthrough opening. In addition, each of the adjacent cages on the top row share a common sidewall that has an internal opening that will accept the guillotine door as it slides upward from the lower cages. In order to serve as effective guillotine door housings, the sidewalls of the cages on the upper row are solid. As a result, the cages in the upper row cannot have pass through capabilities. Further, the upper and lower rows of the cage bank must be vertically aligned so that each guillotine door can move between adjacent cages on the top row.

Another type of “passthrough” feature known in the art is the slidable divider door. This feature has limited application and is commonly used where two adjacent cages do not share a common sidewall. The slidable divider is normally deployed between the side walls of two cages that abut one another. It is operational from outside the cage and can be alternated between an open and a closed position. But there needs to be a specially designed cavity between the cages to accept the divider door and support it to ensure that it will operate properly. Each of the abutting sidewalls must also have aligned openings that allow for passage between the cages when the divider is removed.

In addition to the specific downsides associated with each individual “passthrough” feature discussed above, a common problem with all these features is that they are typically incorporated into a fixed or stationary wall. Thus there is no opportunity to deploy these features in an environment that demands adjustability in the space for housing animals. The present invention overcomes this limitation by incorporating a simple, inexpensive and externally operational “passthrough” feature into a removable divider.

### BRIEF SUMMARY OF THE INVENTION

The present invention is directed toward an animal cage having a divider operable from outside the cages to removably engage one or more of the cage's walls for dividing the interior of the cage into first and second chambers. An opening in the divider allows passage between the two chambers. Within the divider is a door panel or panels that may be operated from outside the cage so as to be moved relative to the divider between a closed position blocking the opening in the divider and an open position allowing passage between the first and second chambers. When the door panel is in its open position, an animal or animals housed within the cage may move freely between the first and second chambers. If one of the chambers needs to be cleaned, the animal or animals within the cage are coaxed to the opposite chamber and the door panel is moved to its closed position preventing the animals from entering the chamber being cleaned. The segregated chamber may then be safely cleaned without interference. If certain animals within the cage need to be separated from each other, the door panel may be moved to its closed position to create two separate chambers for holding the animals. Finally, the divider is removable altogether leaving the entire interior of the cage to function as one large chamber, and the divider can be positioned at various locations within the cage interior to create different size chambers.

The divider may also be used as a support for mounting various structural elements within one or both chambers. For example, the divider may include a support for mounting a shelf, feed container, water bowl or critical care component within one or both chambers. In one embodiment of the present invention, a pair of supports are mounted opposite each other within the first chamber for supporting a shelf within the chamber, and another pair of supports are mounted opposite each other within the second chamber for supporting a shelf within that chamber. One of each pair of supports is preferably mounted to a side wall and the other is preferably mounted to the divider. When a shelf is deployed, the divider preferably has a second opening positioned above the first opening so that animals may move from the shelf in the first chamber to the shelf in the second chamber. With this application, there is preferably also a second door panel that is supported by the divider and that is moveable relative to the divider for alternately blocking and allowing movement through the second opening.

It is believed that in comparison with previous types of animal cages, cats prefer living in a cage as described above with two chambers, a divider panel with upper and lower openings, and a shelf supported within each chamber. If the cage is used to house a cat or cats, litter may be placed on the bottom wall or floor of one of the chambers. When the litter needs to be cleaned or replaced, the cat or cats within the cage are coaxed into the opposite cage and the door panels are moved to their closed position blocking the openings in the divider. In this manner, the litter may be safely cleaned or replaced without interference from the cats in the cage.

In another embodiment of the present invention, a support may be provided on one wall of a divider to mount critical care components. These components preferably include heater/cooling apparatus, oxygen therapy devices and other elements which can be used to aid in the healing of a sick or injured animal within the cage.

In one embodiment of the present invention, the removable divider may be supported within the cage by a runner mounted to one or more interior walls of the cage. The runner preferably has a channel that is operable to slidably receive the divider. In this manner, the divider may be easily inserted into a standard cage if desired or removed if deemed unnecessary for a particular application. In addition, various different configurations of dividers may be inserted to “customize” the cage depending upon the intended purpose or need. For instance, one divider may have multiple small openings and shelving supports as described above, and an alternative divider may have one large opening and a support for a critical care component. The same cage can be easily customized by simply using the preferred divider for a particular situation.

In another embodiment of the present invention, a cage run presents upper and lower elongated enclosures with a row of cage doors presented along the front of the enclosures. The enclosures are constructed so that a removable divider may be inserted into the interior of the enclosure at a location between each cage door so as to create multiple cage compartments within the run. The dividers slide into corresponding runners positioned on one or more of the interior walls of the enclosures. The dividers move in a direction generally perpendicular to the rear walls of the enclosures. Once inserted, the divider acts as a sidewall for adjacent cage compartments. There is an opening in the divider that allows for passage between the cage compartments. Within the divider is a door panel operational from outside the cage run that is movable between closed and open positions for alternatively blocking and allowing movement through the opening and between adjacent cage compartments.

Dividers may be positioned between cage compartments in both the upper and lower enclosures. Because the dividers are fully removable, they may be deployed in various sequences to create various sized cage compartments within each enclosure. Alternatively, the dividers may be removed altogether to transform the enclosure into a large enlongated cage. In addition, because the cage compartments in the upper and lower enclosures do not need to be vertically aligned, provision may be made to vary the standard width of the cage compartments on the upper and lower rows. This is particularly helpful in situations where, for example, there is a need to provide for several small cage compartments on a top row and just a few large cage compartments on a bottom row.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an animal cage according to one embodiment of the present invention;

FIG. 2 is a front elevational view of the interior of the animal cage of FIG. 1;

FIG. 3 is a front elevational view of the interior of the animal cage of FIG. 1 showing shelves supported within the interior;

FIG. 4 is a perspective view of the animal cage of FIG. 1 showing a removable divider with removable door panels;

FIG. 5 is an exploded view of the animal cage of FIG. 1;

FIG. 6 is an exploded view of a divider with a critical care component mounted to the divider.

FIG. 7 is a perspective view of an animal cage run according to another embodiment of the present invention;

FIG. 8 is a front exploded perspective view of the animal cage run of FIG. 7 with portions of the front doors, door frames and dividers broken away.

FIG. 9 is a perspective exploded view of a runner and removable divider with removable door panel of the cage run of FIG. 7; and

FIG. 10 is an exploded view of an alternative embodiment of a removable divider with removable door panel for the cage run of FIG. 7.

### DETAILED DESCRIPTION OF PREFERRED EMBODIMENT

Referring now to FIG. 1, an animal cage according to one embodiment of the present invention is shown generally as 10. The animal cage 10 includes a housing 12 formed from side walls 14 and 16 that are joined with top, bottom, and rear walls 18, 20, and 22. The joined walls 14, 16, 18, 20, and 22 define an interior 24 of the housing 12, which is accessible via an opening 26 that is opposite rear wall 22. Looking to FIGS. 1, 4 and 5, divider 28 positioned within the interior 24 divides the interior into first and second chambers 30 and 32. There are upper and lower openings 34 and 36 in the divider 28 to allow an animal to move between the first and second chambers 30 and 32. As described below and shown in FIGS. 1 and 5, there are first and second door panels 38 and 40 that are slidable within divider 28 for regulating passage through upper and lower openings 34 and 36, respectively. A support member 42 is mounted to the front of the housing 12 between first and second chambers 30 and 32 for retaining the divider 28 within the interior 24. Preferably, the housing 12 is constructed from stainless steel; however, it is within the scope of the invention for the housing 12 to be made from any material.

Looking back to FIG. 1, a first door 44 is mounted to the housing 12 with hinges 46a and 46b and a second door 48 is mounted to the housing with hinges 50a and 50b. First and second doors 44 and 48 are operable to rotate with respect to the hinges 46a, 46b and 50a, 50b, respectively, between open positions allowing access to the first and second chambers 30 and 32, respectively, and closed positions limiting access to the chambers 30 and 32. Preferably, door 44 and hinges 46a, 46b, 50a, and 50b are similar to the door and hinges described in U.S. Patent Application Publication No. 2008/0172947. However, doors 44 and 48 and hinges 46a, 46b, 50a, and 50b may be any type of door and hinge known in the art.

First door 44 is formed from a grid of vertical and horizontal wires 52 and 54 that are joined at intersections thereof. Two of the horizontal wires extend outward from the peripheral edge of the door 44 to form two latch bolts 56a and 56b that are operable to be received by latch keeps 58a and 58b, respectively, mounted on the support member 42 for securing the door 44 in its closed position. The door 44 has four U-shaped loops 59a, 59b, 59c, and 59d that extend upward or downward from the door. Additionally, there are two C-shaped pivot pins 57a and 57b integrally formed with horizontal wires of the door 44 that are received by hinges 46a and 46b, respectively.

Second door 48 is formed from a transparent, polymeric sheet 60 that is joined with clamps 61 to a wire rod loop 62 extending around the peripheral edge of the sheet 60. A U-shaped wire rod handle 64 is joined to the wire rod loop 62 for opening and closing the door. The ends of the handle 64 extend outward from the peripheral edge of the door to form two latch bolts 66a and 66b that are operable to be received by latch keeps 68a and 68b, respectively, mounted on the support member 42 for securing the door 48 in its closed position. Additionally, there are two C-shaped pivot pins 69a and 69b extending from wire 62 that are received by hinges 50a and 50b, respectively.

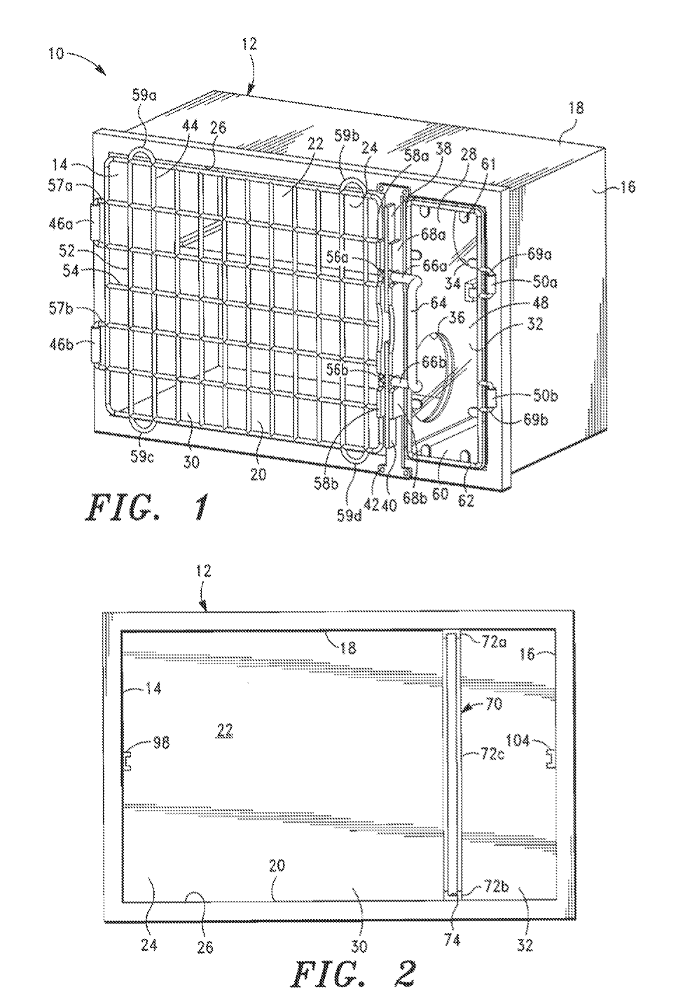

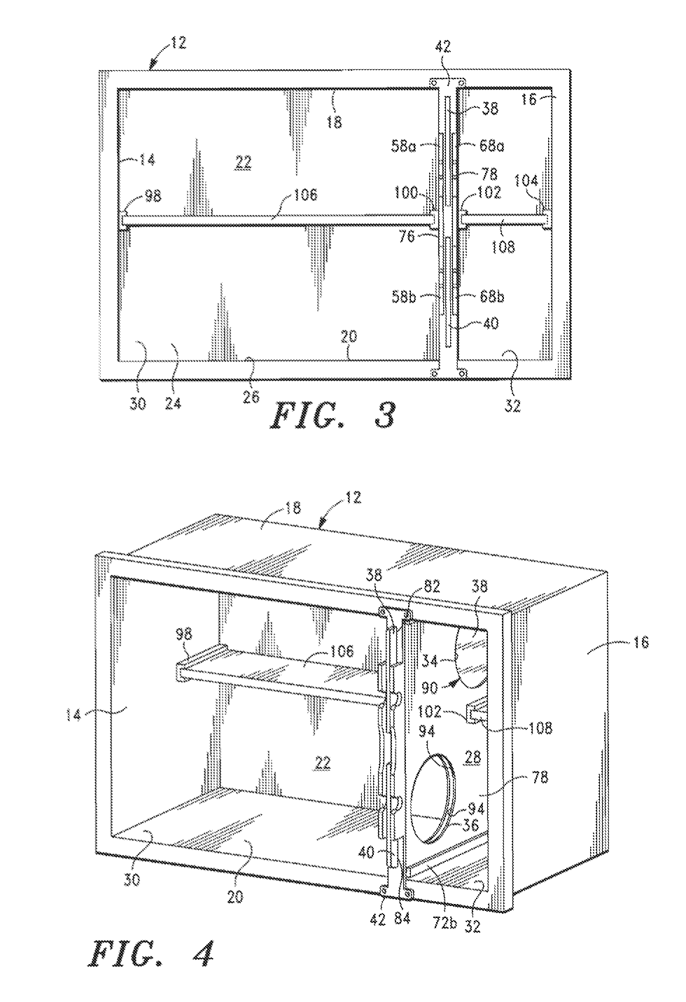

Referring now to FIG. 2, a runner 70 is mounted within the interior 24 of the housing 12 for supporting the divider 28. The runner 70 has top, bottom, and rear portions 72a, 72b, and 72c mounted respectively to top, bottom, and rear walls 18, 20, and 22. The runner 70 is U-shaped to present a channel 74 for slidably receiving the divider 28 and retaining the divider 28 within the interior 24. The divider 28 may be easily removed from and inserted into the housing 12 by sliding it within the channel 74 of the runner 70. Preferably, one or both of the divider 28 and the runner 70 are formed from a polymeric material such as polyethylene to reduce friction when sliding the divider 28 into the interior 24. Preferably, the runner 70 is mounted to walls 18, 20, and 22 with screws received by threaded openings in the walls; however, it is within the scope of the invention for the runner to be mounted in any manner. It is also within the scope of the invention that the runner may be mounted to only one or two walls (such as the top and real walls) or may be mounted in different locations within a cage to create different sized chambers within the same size housing 12. In the embodiment shown in FIGS. 1-5, this would require correspondingly sizing the doors. In addition, the runner may be presented only on the top and rear walls 18 and 22 such that the bottom is free of the runner such that an animal can lay comfortably along bottom wall or floor 20.

Referring to FIG. 5, the divider 28 is formed from first and second sides 76 and 78. The first and second sides 76 and 78 are preferably joined with screws; however, the sides may be joined by any means known in the art. First and second sides 76 and 78 have upper openings 34a and 34b, respectively, which in combination form opening 34 in divider 28. Likewise, first and second sides 76 and 78 have lower openings 36a and 36b, respectively, which in combination form opening 36 in divider 28. There are three spacers 80a, 80b, and 80c joined to first side 76 for defining upper and lower cavities 82 and 84 between the first and second sides 76 and 78.

Upper cavity 82 receives upper door panel 38, and lower cavity 84 receives lower door panel 40. Upper door panel 38 has a first portion 86 with an opening 88 and a second, solid portion 90. Likewise, lower door panel 40 has a first portion 92 with an opening 94 and a second, solid portion 96. Openings 88 and 94 in the upper and lower door panels 38 and 40, respectively, correspond with the openings 34 and 36 in divider 28 such that openings 88 and 94 are operable to be aligned with openings 34 and 36 for allowing an animal to pass through openings 34 and 36. Upper and lower door panels 38 and 40 are reversible so that the panels are operable from outside the cage to either allow passage through openings 34 and 36 or block openings 34 and 36. FIG. 4 shows upper door panel 38 positioned within upper cavity 82 such that the second portion 90 of the upper door panel 38 blocks the opening 34 in the divider 28. FIG. 4 also shows lower door panel 40 positioned within lower cavity 84 such that the opening 94 in lower door panel 40 is aligned with the opening 36 in divider 28.

To allow passage through upper opening 34, upper door panel 38 is removed from upper cavity 82 by grasping it from the outside front of cage and sliding it forward away from rear wall 22. Then, the upper door panel 38 is rotated 180 degrees about an imaginary vertical axis passing through a line of symmetry dividing the first and second portions 86 and 90 of the upper door panel 38. In this position, the upper door panel 38 is inserted into upper cavity 82 such that the opening 88 aligns with the upper opening 34 in the divider 28. To block lower opening 36, lower door panel 40 is removed from lower cavity 84 by grasping it and sliding it forward away from rear wall 22. The lower door panel 40 is then rotated 180 degrees about an imaginary vertical axis passing through a line of symmetry dividing the first and second portions 92 and 96 of the lower door panel 40. In this position, the lower door panel 40 is inserted into the lower cavity 84 such that the solid second portion 96 blocks the lower opening 36 in the divider 28. Thus, both the upper and lower door panels 38 and 40 are easily reversible for either allowing passage through openings 34 and 36, respectively, or blocking openings 34 and 36. Handles (not shown) may be formed in each end of the door panels 38 and 40 to assist in removing and inserting the panels from outside the cage.

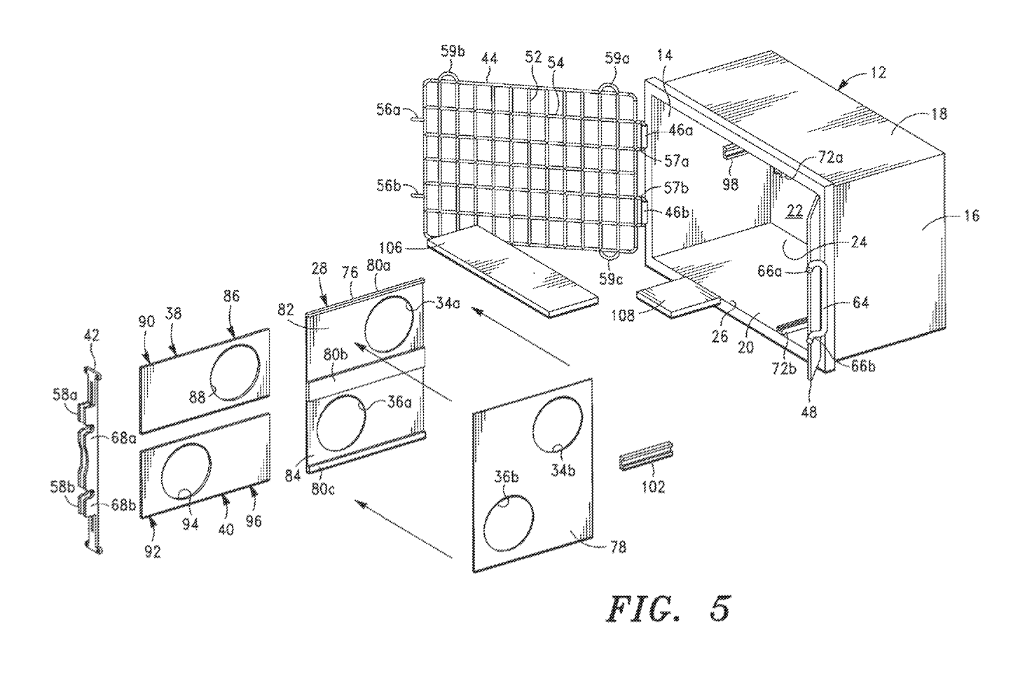

Referring now to FIG. 3, animal cage 10 has first, second, third, and fourth supports 98, 100, 102, and 104 mounted within the interior of housing 12. First support 98 is mounted to side wall 14, second support 100 is mounted to the first side 76 of divider 28, third support 102 is mounted to the second side 78 of divider 28, and fourth support 104 is mounted to side wall 16. Supports 98, 100, 102, and 104 are preferably mounted to side walls 14 and 16 and divider 28 with screws that are received by threaded openings in side walls 14 and 16 and divider 28; however, it is within the scope of the invention for the supports to be mounted in any manner. Each of the supports 98, 100, 102, and 104 is U-shaped to present a channel for receiving and supporting shelves 106 and 108. Supports 98 and 100 receive shelf 106, and supports 102 and 104 receive shelf 108. The shelves 106 and 108 may be easily removed from and inserted into the housing 12 by sliding them within the channels of the supports 98, 100, 102, and 104. Preferably, the supports 98, 100, 102, and 104 and/or the shelves 106 and 108 are formed from a polymeric material such as polyethylene to reduce friction when the shelves 106 and 108 are slid into the cage's interior 24. When upper door panel 38 is inserted into upper cavity 82 so that openings 88 and 34 are aligned, shelves 106 and 108 allow an animal contained within cage 10 to move between first and second chambers 30 and 32 through opening 34.

While cage 10 may be used to contain or house any type of animal, it is particularly well adapted for use in housing a cat or cats. Cage 10 is arranged so that litter may be placed on the bottom wall 20, or in a container placed on the bottom wall 20, within second chamber 32. With the cage 10 arranged in this manner, the caretaker of the cat or cats within the cage 10 may safely clean the litter within second chamber 32 by using door panels 38 and 40 to close openings 34 and 36 from outside the cage, respectively, when the cat or cats are in first chamber 30. With the cat or cats contained within first chamber 30, the caretaker may safely open door 48 to clean the litter within the second chamber 32. Likewise, the caretaker may safely clean first chamber 30 by using door panels 38 and 40 to close openings 34 and 36 from outside the cage when the cat or cats are in second chamber 32. The door panels 38 and 40 may also be used to separate an animal or animals in first chamber 30 from an animal or animals in second chamber 32. Because door panels 38 and 40 are operational from outside cage 10, the need to access the inside of the cage or engage in unnecessary animal handling is minimized.

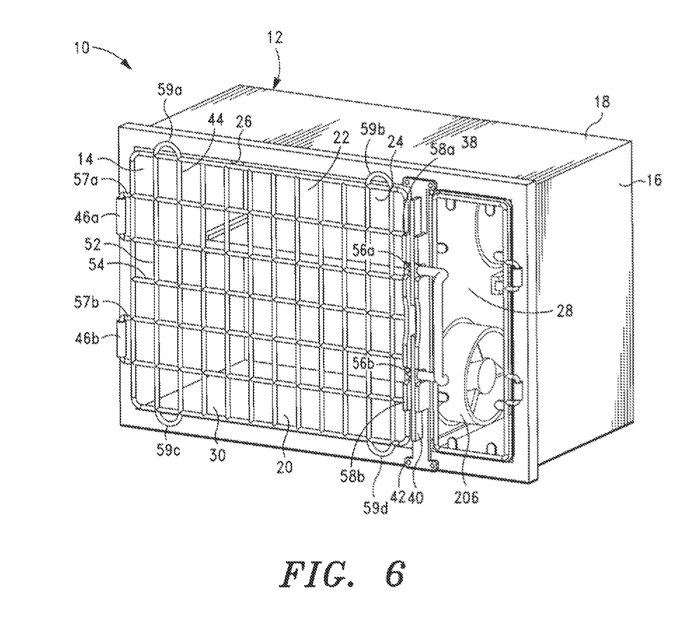

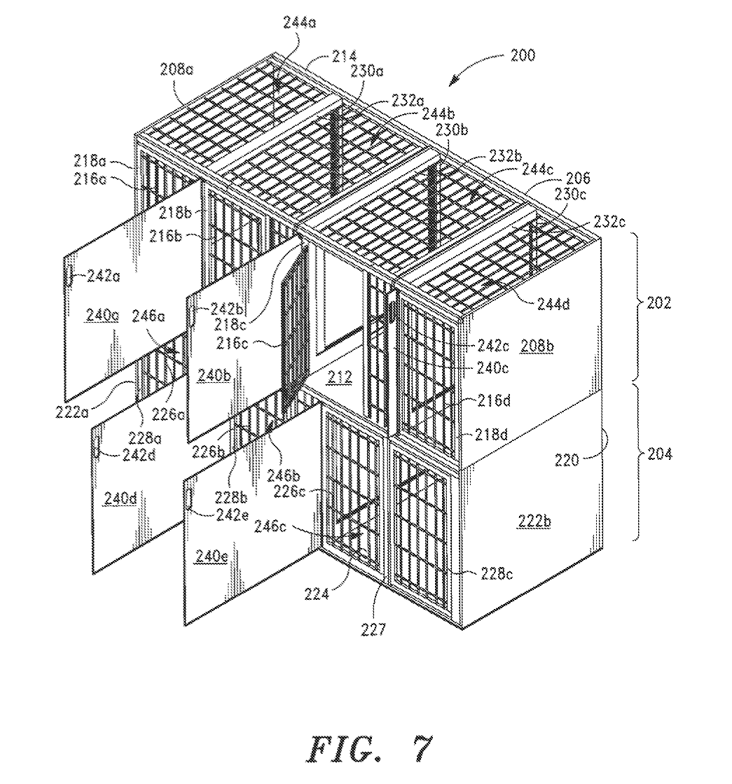

Although supports 98, 100, 102, and 104 are preferably used for supporting shelves 106 and 108, it is within the scope of the invention for any number and variety of supports to be provided on the divider for supporting shelves or other types of accessories desirable to mount within a chamber of the animal cage 10. FIG. 6 shows a divider 28 with a critical care device 206 mounted to first side 76 of divider 28. This particular critical care device is a fan to promote air circulation within the interior 24 of cage 10. Other types of accessories that may be mounted within cage 10 include heaters or other critical care components.

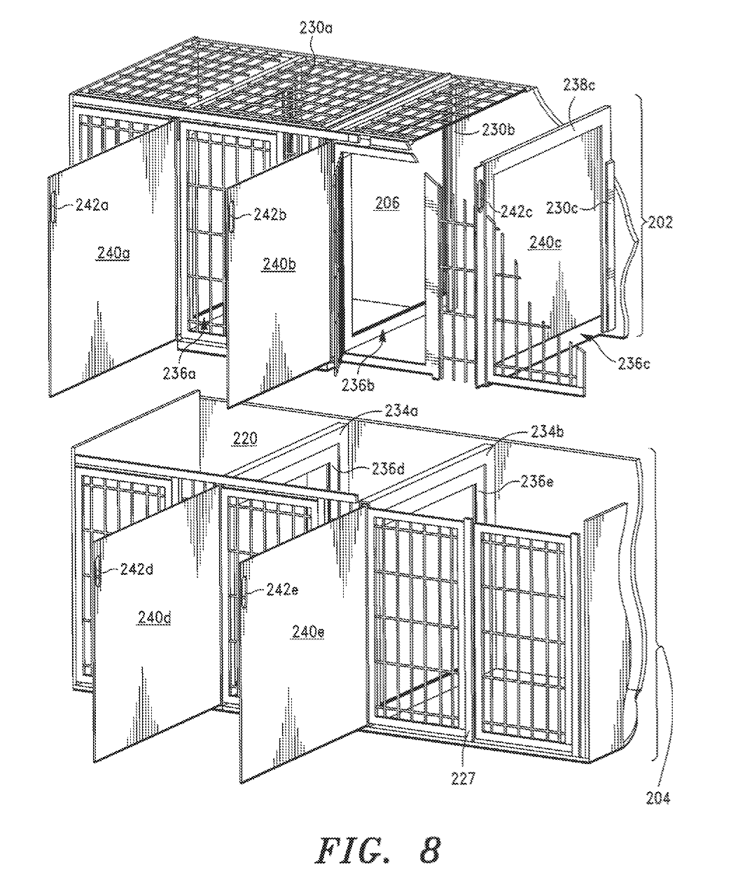

Referring now to FIGS. 7 and 8, a cage run according to an alternative embodiment of the present invention is shown generally as 200. The cage run 200 has an upper elongated enclosure 202 stacked on top of a lower elongated enclosure 204. Upper enclosure 202 is formed from a solid rear wall 206, solid end walls 208a, 208b, a solid bottom wall 212, and a wire grid top wall 214. The opening at the front of upper enclosure is covered by a row of four wire grid doors 216a, 216b, 216c, 216d mounted to door frames 218a, 218b, 218c, 218d that are secured to corresponding portions of the front edges of end walls 208, bottom wall 212 and/or top wall 214. Doors 216 are rotatable with respect to their respective door frames 218 between closed and open positions for accessing the interior of enclosure 202. Preferably, vertical pins (not shown) extend upward and downward from the top and bottom edges of doors 216, respectively, and are received by openings in the door frames 218 thereby allowing the doors to pivot.

Lower enclosure 204 similarly is formed from a solid rear wall 220, solid end walls 222a, 222b, and a solid bottom wall 224. In the embodiment shown, the top wall of the lower enclosure is formed by the bottom wall 212 of the upper enclosure. Of course, an additional wire grid or solid top wall could alternatively be provided. The opening at the front of lower enclosure 204 is covered by a row of three wire grid doors 226a, 226b, 226c mounted to door frames 228a, 228b, 228c that are secured to corresponding portions of the front edges of end walls 222, bottom wall 224 and bottom wall 212. Door 226c is a double door having a support post 227 centrally positioned between the doors. Doors 226 are rotatable with respect to their respective door frames 228 between closed and open positions for accessing the interior of enclosure 204. Preferably, vertical pins (not shown) extend upward and downward from the top and bottom edges of doors 226, respectively, and are received by openings in door frames 228 thereby allowing doors 226 to pivot.

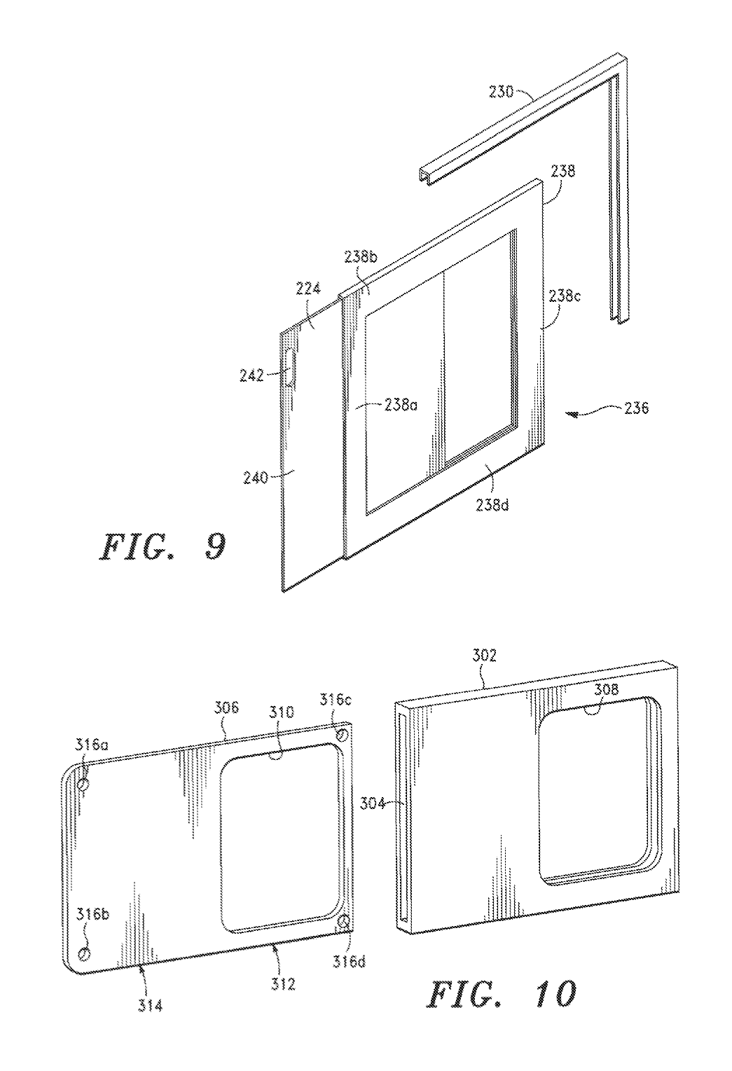

Referring to FIGS. 7 and 9, runners 230a, 230b, 230c are mounted within the interior of upper enclosure 202 at a location between each door 216. A top portion of each runner is mounted in abutting engagement with a corresponding cross support member 232a, 232b, 232c presented in top wall 214. Alternatively, the top portion of each runner 230 could be formed integrally with a corresponding cross support member 232. A rear portion of each runner is mounted in abutting engagement with rear wall 206.

Looking to FIG. 8, similarly, runners 234a, 234b are mounted within the interior of lower enclosure 204 at a location between each door 226. A top portion of each runner is mounted in abutting engagement with the top wall of the lower enclosure formed by the bottom surface of bottom wall 212. A rear portion of each runner is mounted in abutting engagement with rear wall 220.

Looking to FIGS. 8 and 9, runners 230, 234 are configured to slideably receive and retain corresponding dividers 236a, 236b, 236c, 236d, 236e within the interiors of upper and lower enclosures 202, 204 respectively. Specifically, runners 230, 234 are each generally U-shaped in cross section to present a channel along the top and rear walls of the enclosures into which top and rear portions of dividers 236 may be received and retained. Each divider 236 may therefore be easily removed from and inserted into the interior of upper and lower enclosures 202, 204 respectively by sliding the divider within the channel of a corresponding runner 230, 234.

With reference to FIG. 9, each divider 236 comprises a rectangular frame having front, upper, rear, and bottom portions 238a, 238b, 238c and 238d defining a central opening. The frame portions are generally U-shaped in cross section so as to slidably receive a corresponding door panel 240. Each door panel 240 has a handle formed by an opening 242, which can be grasped by a user for sliding the door panel 240 between its open and closed positions. Preferably, one or both of the dividers 236 and door panels 240 are formed from a polymeric material such as polyethylene to minimize friction when the panels 240 are slid into dividers 236.

Looking back to FIGS. 7 and 8, when dividers 236 are secured within the interiors of upper and lower enclosures 202, 204 via runners 230 and 234 respectively, the dividers serve to divide the interiors into cage compartments. Upper enclosure 202 forms a row of four cage compartments 244a, 244b, 244c, 244d and lower enclosure 204 forms a row of three cage compartments 246a, 246b, 246c. Cage compartments 244 within upper enclosure 202 are approximately the same dimension and are smaller in width than cage compartments 246 within lower enclosure 204. Thus, the two rows of cage compartments are not vertically aligned.

Door panels 240 may be used to control access or movement of animals between adjacent cage compartments. Each of the door panels 240 is moveable between a closed position preventing an animal from moving between adjacent cage compartments and an open position allowing an animal to move between adjacent cage compartments. For example, as shown in FIG. 7, door panel 240c is in a closed position. Thus, door panel 240c prevents movement between cage compartments 244c and 244d. Door panels 240a, 240b, 240d, 240e are in their open position. Thus, door panel 240a allows movement between cage compartments 244a and 244b, door panel 240b allows movement between cage compartments 244b and 244c, door panel 240d allows movement between cage compartments 246a and 246b, and door panel 240e allows movement between cage compartments 246b and 246c.

Upper and lower enclosures 202 and 204 may each be formed as a single unit with integral walls or may be formed of individual modular cage units secured adjacent one another in a row via welding, screws or other fastening means. Where individual cage units are secured together to form the enclosure, runners 230, 234 and dividers 236 may be positioned between each cage unit so as to divide the entire interior of each enclosure into cage compartments corresponding in size to the individual cage units. It is anticipated that the cage units in adjacent upper and lower enclosures may be vertically aligned such that the entire top wall of one cage unit forms the entire bottom wall of the above cage unit.

Cage run 200 may be used in a similar manner as cage 10 described above. For example, door panels 240 may be used to block an animal or animals from entering a particular cage compartment so that the cage compartment may be safely cleaned. Further, the door panels may be used to segregate an animal or animals in one cage compartment from an animal or animals in another cage compartment. If the animal or animals contained within the cage compartments on a particular row need not be separated then the dividers and/or panels may be removed to give more space to the animal or animals within the row. In addition, various types of supports may be affixed to the divider for mounting a structural element within any given cage compartment interior.

Referring now to FIG. 10, an alternative type of divider for positioning between adjacent cage compartments in the cage run 200 is shown generally as 302. Divider 302 is a hollow wall which contains a cavity 304 for slidably receiving a door panel 306. In use, divider 302 is positioned between adjacent cage compartments like the divider 236 shown in FIG. 7. Divider 302 contains an opening 308 which corresponds with an opening 310 in door panel 306. Door panel 306 has a first portion 312 containing opening 310 and a second, solid portion 314. There are four holes 316a, 316b, 316c and 316d in door panel 306 for grasping the panel and sliding it into and out of divider 302. Panel 306 can be received by cavity 304 in two positions. In the first position, opening 310 in door panel 306 is aligned with opening 308 in divider 302 so that an animal contained within the two cage component adjacent divider 302 can move between the two cage compartments through openings 308 and 310. In the second position, the second portion 314 of panel 306 is aligned with opening 308 in divider 302 thereby blocking passage between the two cage compartments adjacent the wall 302. Door panel 306 can be moved between these two positions in the same manner as described above for door panels 38 and 40 of cage 10.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. For example, while the dividers have been shown to include certain configurations of openings and supports, it is anticipated that any number of different openings and supports and combinations thereof may be used. In addition, it is within the scope of the present invention for the cage run 200 to contain any number of enclosures or rows of cage compartments (including, without limitation, a single row or multiple stacked rows), and any number of cage compartments within each enclosure or row. The cage compartments may also be made in any size and the size of each cage compartment may vary as illustrated by the size differences between cage compartments 244 and 246. It is also within the scope of the present invention to substitute one or more of the runners and divider panels for solid walls to prevent passage between certain adjacent cage compartments. It is also within the scope of the present invention for one or more of the cage compartments to have a stationary front wall in lieu of a pivoting front door.

Further, it will be understood that certain features and subcombinations are of utility and may be employed without reference to other features and subcombinations. This is contemplated by and is within the scope of the claims.

What is claimed and desired to be secured by Letters Patent is as follows:

1. An animal cage, comprising:
a plurality of joined walls defining an interior and presenting a first opening for accessing said interior;
a divider operable to removably engage at least one of said walls for dividing said interior into first and second chambers, said divider presenting a second opening for passage between said first and second chambers; and
a door panel supported by said divider and operational from outside the cage so as to be moveable relative to said divider between a closed position blocking said second opening within said divider and an open position allowing passage between said first and second chambers.

2. The cage of claim 1, further comprising a runner mounted to one of said walls, said runner comprising a channel operable to slidably receive said divider.

3. The cage of claim 2, wherein said runner comprises polyethylene.

4. The cage of claim 2, wherein said joined walls comprise a pair of opposed side walls each joined with a top wall, a bottom wall, and a rear wall to present said first opening opposite said rear wall, and wherein said runner comprises a rear section mounted on said rear wall, and an upper section mounted on said top wall.

5. The cage of claim 1, wherein said joined walls comprise a pair of opposed side walls each joined with a top wall, a bottom wall, and a rear wall to present said first opening opposite said rear wall, and wherein said door panel is moveable from said closed position to said open position through said first opening.

6. The cage of claim 1, further comprising a support mounted on said divider, said support being operable to support an accessory.

7. The cage of claim 6, wherein said support comprises a first support and further comprising a second support mounted on one of said walls generally opposite said first support, said first and second supports operable to support said accessory.

8. The cage of claim 7, wherein said accessory comprises a shelf.

9. The cage of claim 8, wherein each of said first and second supports comprises a channel operable to slidably receive said shelf.

10. The cage of claim 7, wherein said divider comprises a first surface accessible within said first chamber and a second surface accessible within said second chamber, wherein said first support is mounted to said first surface and further comprising a third support mounted to said second surface of said divider and a fourth support mounted on one of said walls generally opposite said third support for supporting another accessory.

11. The cage of claim 10, wherein said accessory comprises a first shelf and said other accessory comprises a second shelf.

12. The cage of claim 11, wherein said divider presents a third opening positioned above said second opening, wherein said door panel comprises a first door panel, and further comprising a second door panel supported by said divider and moveable relative to said divider between a closed position blocking said third opening within said divider and an open position allowing passage from said first shelf in said first chamber to said second shelf in said second chamber.

13. The cage of claim 6, wherein said accessory comprises a critical care component.

14. The cage of claim 1, further comprising a support member mounted to one or more of said walls for retaining said divider within said interior.

15. The cage of claim 14, wherein said animal cage additionally comprises:
a first door mounted to one of said walls adjacent said first opening and moveable between a closed position limiting access to said first chamber and an open position allowing access to said first chamber; and
a second door mounted to one of said walls adjacent said first opening and moveable between a closed position limiting access to said second chamber and an open position allowing access to said second chamber.

16. The cage of claim 15, further comprising a first latching mechanism mounted on said support member that is operable to receive a first latch bolt of said first door, and a second latching mechanism mounted on said support member that is operable to receive a second latch bolt of said second door.

17. The cage of claim 15, wherein said first door comprises a wire grid and said second door comprises a polymeric sheet.

18. The cage of claim 1, wherein said divider comprises joined opposed sides presenting a cavity positioned between said opposed sides, said door panel moveable from its open position to its closed position within said cavity.

19. The cage of claim 1, wherein said door panel comprises first and second portions, said first portion presenting a third opening that aligns with said second opening in said divider when said door panel is in its open position, and said second portion blocking said second opening when said door panel is in its closed position.

20. An animal cage, comprising:
first and second side walls each joined with a top wall, a bottom wall, and a rear wall, said joined walls defining an interior and presenting a first opening opposite said rear wall for accessing said interior;
a runner mounted to at least one of said walls, said runner comprising a channel;
a divider operable to be removably and slidably received by said channel for dividing said interior into first and second chambers, said divider presenting a second opening for passage between said first and second chambers;
a door panel supported by said divider and operational from outside the cage so as to be moveable relative to said divider between a closed position blocking said second opening and an open position allowing passage between said first and second chambers;
a first door mounted to said first side wall adjacent said first opening, said first door moveable between a closed position limiting access to said first chamber and an open position allowing access to said first chamber; and
a second door mounted to said second side wall adjacent said first opening, said second door moveable between a closed position limiting access to said second chamber and an open position allowing access to said second chamber.

21. The cage of claim 20, further comprising first and second supports mounted respectively on said first side wall and said divider for supporting a first shelf, and third and fourth supports mounted respectively on said second side wall and said divider for supporting a second shelf.

22. The cage of claim 21, wherein said divider presents a third opening positioned above said second opening, wherein said door panel comprises a first panel, and further comprising a second door panel supported by said divider and moveable relative to said divider between a closed position blocking said third opening and an open position allowing passage between said first and second chambers.

23. The cage of claim 22, further comprising a support member removably mounted to said top and bottom walls for retaining said divider within said interior, a first latching mechanism mounted on said support member that is operable to receive a first latch bolt of said first door, and a second latching mechanism mounted on said support member that is operable to receive a second latch bolt of said second door.

24. The cage of claim 20, wherein said divider comprises joined opposed sides presenting a cavity positioned between said opposed sides, said door panel moveable from its open position to its closed position within said cavity.

25. The cage of claim 20, wherein said door panel comprises first and second portions, said first portion presenting a third opening that aligns with said second opening in said divider when said panel is in its open position, and said second portion blocking said second opening when said divider is in its closed position.

26. A cage run comprising:
an elongated enclosure formed by a plurality of joined walls defining an interior and presenting a first opening for accessing said interior;
a plurality of doors mounted over said first opening, said doors moveable between a closed position limiting access to said interior and an open position allowing access to said interior;
a plurality of dividers, each said divider operable to removably engage at least one of said walls for dividing said interior into two adjacent compartments and presenting a divider opening for passage between the adjacent compartments;
a plurality of door panels corresponding to said plurality of dividers, each said door panel operational from outside the cage run so as to be moveable relative to said corresponding divider between a closed position blocking said divider opening and an open position allowing passage between adjacent compartments.

27. The cage run of claim 26, further comprising a plurality of runners corresponding with said plurality of dividers, each of said runners mounted to at least one of said walls and comprising a channel operable to slidably receive said divider.

28. The cage of claim 27, wherein each of said runners is positioned between adjacent doors.
